(19) United States
(12) Patent Application Publication
(10) Pub. No.: US 2006/0163403 A1
(43) Pub. Date: Jul. 27, 2006

(54) Spincast fishing reel with top-mounted quick-change line spool

(76) Inventor: Richard M. Dickson, Milwaukie, OR (US)

Correspondence Address: Mr. Richard M. Dickson, 4877 SE Jackson Street, Milwaukie, OR, 97222, US

(21) Appl. No.: 11/090,601

(22) Filed: Mar. 26, 2005

Related U.S. Application Data
(60) Provisional application No. 60/641,582, filed on Jan. 4, 2005.

(51) Int. Cl. A01K 89/01

(52) U.S. Cl. 242/323

(57) ABSTRACT

A spincast fishing reel consisting of a frame in which the line spool is mounted horizontally above the reel frame and gear box assembly inside a round, lidded line canister, positioned horizontal to the horizontal plane. The line spool used is a commercially available plastic line manufacturer's dispenser spool in lieu of an internal reel spool. The line dispenser spool is mounted on a central line spindle, inside the line canister. A drag thumb wheel button is mounted centrally atop the line canister, followed by a capstone quick release line spool twist knob, which is also connected to the line spindle inside the line canister. A spring mounted line release lever protrudes out the back side of the reel frame through an open slit in the reel frame cover. Cast line exits the top mounted line canister through a grommeted aperture mounted at the front, and facing the direction of the rod guides.

### CROSS-REFERENCE TO RELATED APPLICATIONS

This application claims benefit of U.S. Provisional Applications Ser. Nos. 60/641,582 filed Jan. 4, 2005 and 60/495,256 filed Aug. 13, 2003.

### STATEMENT REGARDING FEDERALLY SPONSORED RESEARCH OR DEVELOPMENT

Not applicable

### REFERENCE TO SEQUENCE LISTING, A TABLE OR A COMPUTER PROGRAM LISTING COMPACT DISK APPENDIX

Not applicable

### BACKGROUND OF THE INVENTION

1. Field of the Invention

The present invention relates to fishing reels, and more particularly closed faced fishing reels, commonly known as spincast reels, and to fishing reels which employ a quick-change spool system.

Currently, fishing reels utilize a rigid spool integrated into the fishing reel for holding the fishing line. These fishing line spools are expensive to manufacture and are fitted into the body of the sport fishing reel. However, these line spools can generally be removed and replaced with auxiliary fishing line spools, spooled with fishing line of different strength, type, or length to accommodate changing fishing conditions. However, this system suffers from two serious drawbacks: (1) the fishing line must be tediously re-spooled from the plastic fishing line dispenser spool, sold by the fishing line manufacturer, onto the fishing reel line spool. This is usually accomplished by inserting a pencil or stick through the central opening in the plastic fishing line dispenser spool and then tying the free end of the line to the fishing reel line spool, before hand-cranking the line onto the fishing reel line spool. This process can take some time; and (2) the extra fishing reel line spools needed to accommodate additional fishing line changes are relatively expensive to purchase from the fishing reel manufacturers, not to mention bulky and awkward to transport while fishing.

Additionally, no prior art fishing reel design utilizes a fishing line spool mounted atop the fishing reel gear box assembly and in such a position that the line spools horizontal to the horizontal plane. For example both spincast and open face spinning reels utilize a line spool that is mounted perpendicular to the horizontal plane; and baitcasting reels have line spools mounted vertical to the horizontal plane. Thus, the positioning of the line spool in the proposed invention makes for longer and more controlled casting, since the line spools off the reel with less resistance when the bait or lure is cast, because it is not twisted or bent in opposition to the force propelling it (i.e., the weight of the lure or bait being cast by the reel), because the line spools freely in a straight line with little resistance or drag. This means that longer casts with less line kinks and twists, which impede casting accuracy, are achievable with the proposed invention.

Other advantages to the proposed invention include: (1) less expense to manufacture than existing fishing reels, since the proposed invention does not include an internal fishing line spool, but instead integrates the commercially available plastic fishing line dispenser spools, made by fishing line manufacturers, directly into the reel body design; (2) faster and easier fishing line spool changes than presently possible with current fishing reel designs, since line does not have to be re-spooled from the plastic fishing line dispenser spool to an internal fishing reel line spool; and (3) because the re-spooling of line is eliminated, the reel is easier to use for older and younger fisherman, who may be less ambidextrous due to developmental and neurological conditions relevant to their ages.

2. Description of the Related Art

Attempts to innovate quick change line spool systems for fishing reels are well-known from the prior art. However, none of the prior art involves systems, which incorporate the plastic fishing line manufacturers' line dispenser spools directly into the fishing reel design, but instead either rely upon complicated cartridge and mechanical loading systems for getting the fishing line onto the fishing reel line spool or require extensive modification to the traditional fishing reel line spool design. Thus, no prior art currently exists like the proposed invention, which incorporates the unmodified commercially available plastic fishing line dispenser spools made by the fishing line manufacturers directly into a sport fishing reel body design, obviating the need for an internal fishing reel line spool.

U.S. Pat. No. 5,195,699 to Stinnette proposes a new type of fishing reel line spool, built in two parts, which then detach and quickly release from one another to reduce fishing line changing time to just a few minutes. However, this prior art retains the concept of the internal fishing line reel spool. It just innovates a clever new version.

U.S. Pat. No. 5,755,391 to Sacconi proposes a new type of fishing reel that utilizes removable lockable cartridge line spools, which utilize a spring lever system. Again this prior art retains the concept of an internal fishing reel line spool, but upgrades it to a cartridge format.

U.S. Pat. No. 6,224,011 to Gavaza, III proposes a fishing line spool holder for facilitating transfer of fishing line from the line manufacturer's spool to the fishing reel. However, this is an external device not integrated directly into the body of the fishing reel design. There is a long history of prior art for external line re-spoolers (some unrelated to sport fishing applications). Some other examples include the following U.S. patents: U.S. Pat. No. 902,787 to Wiebke; U.S. Pat. No. 1,795,043 to Ross; U.S. Pat. No. 2,727,702 to Latincich; U.S. Pat. No. 3,215,361 to Jones, Jr.; U.S. Pat. No. 3,647,155 to Jorgenson; U.S. Pat. No. 3,951,354 to Bagby; U.S. Pat. No. 4,322,198 to Zuber; U.S. Pat. No. 4,360,172 to Cope; U.S. Pat. No. 4,555,862 to Panasewich; U.S. Pat. No. 4,708,244 to Fish et al.; U.S. Pat. No. 4,780,982 to Black et al.; U.S. Pat. No. 4,848,059 to Lewitt; U.S. Pat. No. 4,858,784 to Totten; U.S. Pat. No. 5,544,839 to Burch; and U.S. Pat. No. 5,725,172 to Koehler et al.

U.S. Pat. No. 6,015,111 to Berke proposes a fishing line exchanger and method using flanged fishing reel line spools and an external storage device.

U.S. Pat. No. 5,911,378 to Plestan proposes a quick change open face spinning reel line spool However, this invention improves upon existing open face spinning reel line spool design, but does not propose a solution for obviating the need for the fishing reel line spool itself. U.S. Pat. No. 5,607,114 to Henriksson proposes another variant on the open-face spinning reel line spool design.

U.S. Pat. No. 6,712,300 to Carlebach et al. at first glance has elements that would seem to relate to the proposed invention; but close examination reveals that it proposes a complicated cartridge system of fishing line spools mated to the fishing reel body cavity. Additionally, the aforesaid Carlebach et al. patented quick-change fishing reel spool system requires extensive manufacturing modification to the current design of fishing line dispenser spools provided by the fishing line manufacturers. However, since the preferred embodiment of the proposed invention breaks new technical ground with an entirely new system for quick changing fishing reel line spools by incorporating unmodified commercially available fishing line dispenser spools, provided by the fishing line manufacturers', directly into a new type of fishing reel body design, thus obviating the need for an internal line spool in the fishing reel to hold the fishing line, the proposed invention is outside of the scope of the aforesaid Carlebach patent

Finally, no prior art exists that substantially alters the configuration of the traditional spincast type reel design from a central body with front and rear covers attached; and with the frame, including a fixed line spool hub, which extends forward of the main body and gear box, on which the fishing line is wound. In this traditional design configuration, a pickup device winds the line around the spool when the handle is cranked; and the line spool, as previously mentioned, is mounted perpendicular to the horizontal plane, so that line spools off in loops rather than in a straight line. These loops are more controlled than an open face spinning reel, because both the line spool and pickup device on a spincast reel are enclosed with a cover and hole at the front of the cover to allow the line to exit. However, in the preferred embodiment of the proposed invention, the line spool is mounted in an enclosed cover atop the reel body and gear box and lying horizontal to the horizontal plane, so that line spools freely in a straight line from the reel to the fishing lure or bait. Additionally, the preferred embodiment of the proposed invention utilizes the line manufacturers' plastic line dispenser spool in lieu of an internal reel spool. Additionally, this spool is not fixed, but can be easily replaced with another manufacturer's plastic line dispenser spool as desired.

### BRIEF SUMMARY OF THE INVENTION

A new variant of a spincast fishing reel, which, according to the preferred embodiment, consists of a metal reel frame, which includes a helical and pinion gear box assembly, connected to a spring assisted spool release lever and fishing reel handle, and a centered spool support, which is spring-loaded, so that it can be extended upward through a hole passing through the pinion gear and into a top mounted, lidded line holding canister, which contains the plastic line dispenser spool purchased separately and made by the various fishing line manufacturers. The line dispenser spool is loaded directly through the hole in its center onto the proposed fishing reel's line spindle, so that the line dispenser spool can freely rotate. It should be noted that the tip of the proposed fishing spool support is a narrow flat-topped screw, which is screwed into threads bored into the line spindle, which is in the lidded line canister. The line spindle is thus held tightly in the lidded canister by means of spring tension exerted by the spring around the spool support in the reel body. Likewise, the pinion gear is kept in place by this same spring tension, since the spool support runs through the hollow pinion gear, before connecting to the larger diameter line spindle in the lidded canister mounted above the main reel frame body. The line spindle, in turn, which is of smooth finish in its middle for ease of lubrication and to help the plastic line dispenser spool spin more freely, is connected to a drag button, mounted atop the lidded canister over the center hole, via screw threads on its upper portion. Where the screw threads meet the smooth portion of the spindle is a small metal flange with a rounded end, which extends out over the plastic line dispenser spool. This flange is part of the spindle assembly and serves as a catch to hold the plastic line dispenser spool when the reel handle is cranked. A hard rubber washer with a central hole is also mounted on the upper part of the line spindle before the drag button. The washer provides conventional drag tension. The hard rubber washer base plate has a central mounting hole that is cut through half its radius to allow access for the flange to pass through, and lie on the same flat horizontal plane. Atop the drag button is a quick release twist knob permanently affixed to the end of the line spindle, so that the lidded line canister can be quickly opened and the plastic line spool dispenser quickly replaced.

### BRIEF DESCRIPTION OF THE DRAWINGS

FIG. 1 is a side cutaway view of the preferred embodiment of the proposed fishing reel invention showing the relationship of all internal components.

FIG. 2 is an exploded perspective view of the preferred embodiment of the proposed fishing reel invention showing the relationships of all internal components.

### DETAILED DESCRIPTION OF PREFERRED EMBODIMENTS

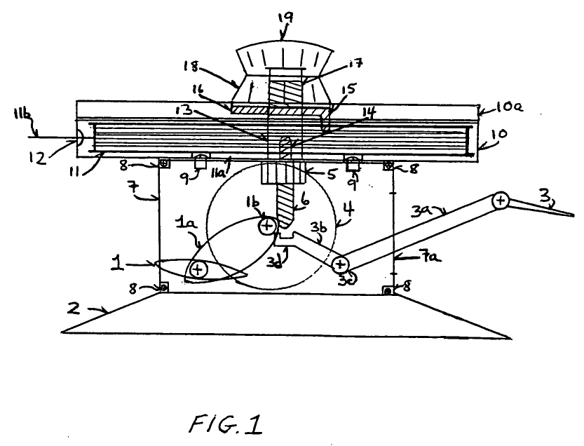

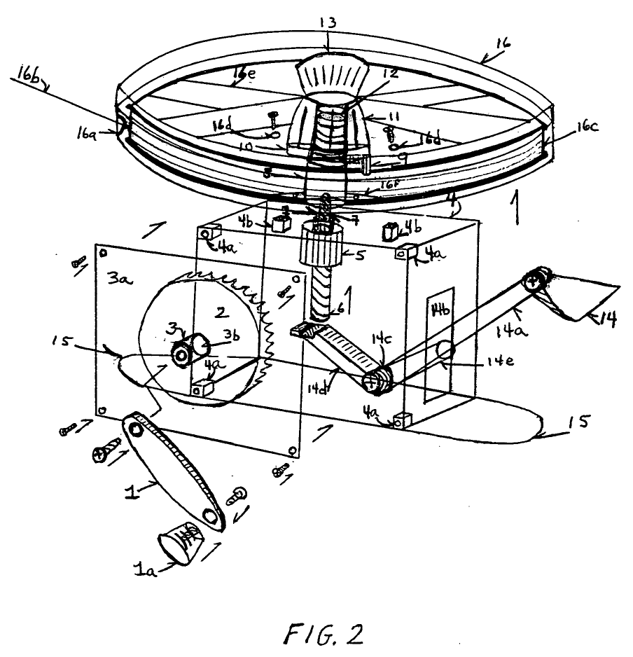

Now referring to FIGS. 1 and 2, both make adequate disclosure of the proposed fishing reel invention to someone with ordinary skill in the art. It should be noted that FIGS. 1 and 2 are not true to scale, but that by varying size and distances of component parts, improved performance will be achieved for the preferred embodiment of the proposed invention.

Referring to FIG. 1, the fishing reel handle 1 and the handle lever 1a, which is connected by a screw to the helical gear 4, located inside the reel body face plate 7. The reel seat is at 2. The spool release lever handle 3 connects to the long lever handle arm 3a, and passes out of the reel frame body through a slit manufactured in the reel frame 7a. The short lever arm 3b is mounted below the spring loaded spindle support 6. It should be noted that there is an indentation at the end of the short lever arm at 3d to catch and temporarily hold the line support hub 6 when the spool release lever 3 is depressed. A tension spring 3c, between and connecting lever arms 3a and 3b, improves leverage. The tension spring 3c is mounted around a post manufactured into the reel body., along with the two lever arms, 3a and 3b. The toothed helical gear 4 is mounted at a right angle to the pinion gear 5, and the teeth on the helical gear engage the pinion gear. The helical gear is connected to the reel handle via screw at 1b, which passes through the reel faceplate 7 and into a threaded post fixed to the helical gear The four screw thread mounts at 8 are manufactured into the main reel frame body and hold the faceplate cover at and the helical gear 4 with reel handle lever at 1a in position against the pinion gear 5 when the screws are attached. The spool support 6 is mounted perpendicular to the horizontal plane and has a strong spring fastened at its tip and coiled in a downward spiral about its axis. The spool support passes through the hollow pinion gear 5 and up into the lidded canister 10 (via a central hole in the canister) where its tip is threaded and screws into a central thread mount 14 located inside the line spindle 13. The plastic line dispenser spool 11 is mounted through its center hole onto the line spindle where it rests on a smooth elevated plastic base 11a through which screws are connected to thread mounts in the reel frame below 9, holding the elevated plastic base and lidded canister in position. The free end of the line 11b on the plastic dispenser spool exits the lidded canister through a grommeted hole 12. The grommet can either be of smooth metal, like brass, or other material, such as Teflon. The grommet serves to reduce line abrasion during casting. A metal flange 15 is manufactured into the line spindle above the plastic line dispenser. The flange extends out from the spindle, parallel to the horizontal plane, the same distance as the radius of the drag button 18, before descending downward at a right angle. This shape resembles the letter “L” and the flange serves to rotate the plastic line dispenser spool when the handle is cranked in order to retrieve the cast line. The flange is covered by a hard rubber washer 16, which is the diameter of the base of the drag button 18, and above the rubber washer the drag button is hollow and threaded in its center 17 to accommodate the screw threaded portion of the upper line spindle. It should be noted that the top canister lid at 10a has a central hole equal in size to the diameter of the base of the drag button 18 to allow passage of the spindle with flange, rubber washer, drag button and quick release twist knob when the canister lid 10a is removed. Finally the very top of the line spindle is permanently affixed to the inside of the quick release twist knob 19 mounted atop the drag button.

The operation of the preferred embodiment of the proposed invention is discussed as follows and relates to the component parts discussed and enumerated above. The quick release twist knob, atop the line canister lid, is twisted counterclockwise until the line spindle unscrews and separates from the line support. At this point, the line spindle and drag nut assembly are removed from the canister, and then the line canister lid is popped-off and a plastic line dispenser spool is placed in the canister by resting it atop the spool support, so that the tubular line spindle can pass through the central hole in the plastic line dispenser spool. The free end of the fishing line is then pulled through a grommeted hole in the side of the lower body of the lidded line canister, so that it can later be threaded through the fishing rod line guides and attached to a lure or bait for casting. The canister lid is then snapped back on top of the canister, so that the central hole in the canister lid rests directly over the line support. Now the line spindle is inserted in the screw threads on the spool support, followed by placement of the hard rubber washer and then the drag knob itself, which sits over its screw threads on top of the line spindle. The quick release twist knob is now screwed clockwise, which threads the line spindle into the spool support. Then the drag button is screwed down until the proper line tension is achieved. Note that the hole in the top of the lidded canister lid is large enough to accommodate the drag button, spindle with metal flange and rubber washer. To cast the reel, the rod is brought back over the shoulder or sideways to the body at about the two o'clock position and then whipped forward to stop at about the ten o'clock casting position either vertically (if casting overhead) or horizontally (if casting sideways). At the ten o'clock position, the spool release lever is depressed, whereby it places tension on the spring connecting the long and short lever arms, and forcing the short lever arm, mounted at a right angle to the first lever and touching the base of the spring loaded spool support, upward so that the spring loaded spool support nestles in the cup-like indentation of the short lever arm. The action of the short lever arm then compress the spring, wound and fastened around the spool support, and forces the spool support upward through the hollow pinion gear, and into the lidded line canister where it elevates the line spindle above the plastic support base, thus removing both the spool support spring tension and drag tension from the plastic line dispenser spool. The line dispenser spool now has no resistance or drag acting on it and spins freely, releasing line in the direction of the lure or bait force vectors through the grommeted line exit hole in the side of the lidded line canister. When the bait or lure impacts the water, the quick release lever is released and the spool support and line spindle are pulled back down by the spring attached to the spool support connected to the line spindle and descend to their original positions immediately stopping the plastic line dispenser spool from freely rotating and releasing line, as the force of the spool support spring vectors downward, coupled with the additional resistance of the drag button to bear on top of the plastic line dispenser spool at the same time. Simultaneously, the small metal flange, mounted atop the line spindle, but before the drag assembly, reengages and allows the plastic line dispenser spool to be rotated by the reel handle and gear assembly, as the metal flange turns in the direction of the reel handle cranking, pushing against one of the axles of the plastic line dispenser spool to force it to rotate in the same direction. In the event the flange rests atop an axle spoke of the plastic line dispenser spool, its rounded edge causes it to slide off into the space between the line spoke axles where it then engages one of the axle spoke sides as the reel handle is cranked. By this means, the cast line is retrieved and re-spooled back onto the plastic line dispenser spool contained in the lidded line canister.

Referring to FIG. 2, the fishing reel handle assembly 1 is connected to the helical gear 2 via screw, and the helical gear has a screw threaded spindle at 3, which passes through the side cover plate for the reel frame 3a via a hole at 3b. The reel frame body 4 is shown as rectangular in shape in the preferred embodiment for ease of manufacture, but could be any shape. Screw threaded mounting posts in the reel frame body for the side cover plate are at 4a. Likewise, screw threaded mounting posts in the top of the reel frame body for the lidded canister are at 4b. The hollow pinion gear 5 is pierced by the spool support with coiled and fastened spring 6. The spool release lever consists of three parts, the first being the short lever arm 14d with cuplike indentation to cradle the spool support 6. This lever arm is connected to the long lever arm 14a at the mounting post 14e via a screw which passes through the hollow ends of both the short and lever arm, separated by a coiled spring 14c sandwiched between lever arm 14d and 14a at the screw juncture in the 14e mounting post. The coiled spring 14c is attached to both lever arm 14d and 14a and provides critical lever tension when the thumb release 14 is depressed at the end of the long lever arm 14a and moves downward through the slit in the reel frame 14b. The spool support at 6 passes through the pinion gear at 5, and then has a screw threaded tip at 7 that enters the top-mounted lidded line canister 16 where it goes through an elevated plastic line spool support base 16f before being screwed into the hollow middle thread mount of the line spindle 8. The 16f elevated plastic support base has two holes aligned with the lid canister mounting holes at 16d, which in turn align with the screw mounting posts in the reel frame body at 4b, so that two screws secure all three parts. An “L” shaped flange 9 extends outward from the line spindle and parallel to the plastic line dispenser spool 16 in the line canister, before angling downward at a right angle to the line canister 16. It should be noted that this flange extends no further than the radius of the drag button knob 11. Just above the flange 9 is the hard rubber washer 10 which has a center hole for the line spindle 8 and is slit on the radius over the flange 9 to allow the washer and the flange to rest on the same horizontal plane atop the line spool 16c. The interior of the drag button 11 is hollow in the center and has thread mounts to accommodate the screw threads 12 on the top portion of the line spindle 8. The line spindle 8 is also permanently affixed to the capstone quick release twist knob 13 mounted atop the drag button 11. The reel seat is shown at 15. The grommeted line aperture opening in the lidded canister is at 16a where the free end of the line 16b from the line dispenser spool 16c passes through on its way to the fishing rod line guides. The lidded line canister 16 is mounted to the reel frame 4 via screws and holes in the canister at 16d. The plastic line dispenser spool axle spokes at 16e are impacted by the flange at 9 when the reel handle 1 is cranked causing the line to wind onto the line dispenser spool.

What is claimed is:

1. A fishing reel and quick-change line system comprising
a. A round lidded, fishing line holding canister, which is mounted on top of the reel frame, above the gear box assembly, and lying horizontal to the horizontal plane. The top portion of the lidded canister can be popped on or off the lower portion. The canister can be made of metal or plastic.
b. Integration of the disposable fishing line manufacturers' plastic line dispenser spool into the top-mounted fishing reel line canister in lieu of a traditional fishing reel line spool manufactured as a reel component.
c. A unique spindle unit mounted inside the fishing line canister mentioned in claim 1a above, which holds the line dispenser spool mentioned in claim 1b above, and allows it to freely rotate when a spool release lever is activated. Said spindle unit is tubular in shape and is mounted via screw thread to a spool support located below the line canister in the reel frame body. Said spindle unit also has a metal flange which extends outward, perpendicular to the spindle shaft and into the lidded canister, the end of which bends downward at a right angle to form a smooth “L” shape.
d. “L” shape flange mentioned in claim 1c above, which serves to retrieve the fishing line when the fishing reel handle is cranked by rotating the support hub and attached spindle, which then forces the “L” shaped flange against the side of one of the plastic line dispenser spool axle spokes, thus turning the line dispenser and winding the line onto the spool.
e. A spring loaded spool support, mounted in the reel body and passing through a hollow pinion gear, and then through the top of the reel frame where it is threaded to the line spindle mentioned in claim 1c in the lidded canister.
f. A drag button, which sits atop the center of the lidded line canister, mentioned in claim 1a above, and has a solid hard rubber base, except for a hole for the line spindle and slit for the flange mentioned in claim 1d above. Said drag button is hollow in its center with screw thread depressions that are matched to screw threads in the top of the spindle unit mentioned in claim 1c above. Thus, the drag button can be screw tightened to increase or decrease drag pressure on the line spool held in the lidded canister mentioned in claim 1a above.
g. A capstone quick release twist-off knob mounted atop the drag button mentioned in claim 1f above. The capstone quick release twist-off knob is permanently affixed to the top of the spindle unit mentioned in claim 1c after it passes through the hollow drag button, and serves as a quick release mechanism for detaching the spindle unit from the spool support in order to allow the plastic line dispenser spool mentioned in claim 1b to be quickly removed from or inserted into the lidded line canister mentioned in claim 1a.
h. A spool release lever consisting of two metal or plastic arms, mounted at right angles to each other in the reel frame body and connected via a screw and post arrangement with a tension spring connecting the two ends of the lever arm together at the mounting post. The lever arms have holes in their ends and are mounted through the post, which is manufactured into the reel frame body behind the gear assembly.
i. The rear lever arm mentioned in claim 1h above, which extends out the back of the reel frame body through a slit in the body and has a flat thumb knob on its end that is depressed to activate casting.
j. A secondary lever arm mentioned in claim 1h above, which is connected to the rear lever arm, mentioned in claim 1i above, and which extends upward at a right angle to the rear arm at the mounting post, mentioned in claim 1h above.
k. A small, cup-shaped indentation at the tip of the secondary lever arm, mentioned in claim 1j above, which cradles the spool support, mentioned in claim 1c above, and which levers said spindle support upwards when the thumb knob on the rear lever arm mentioned in claim 1i is depressed, thus forcing contraction of the spring around the spindle support, and extending the upper portion of the spool support into the lidded line canister, elevating the spindle unit and allowing the plastic line dispenser spool to spool freely.
l. A grommeted hole in the middle of the fishing lid canister side facing the fishing rod line guides, which allows the free end of the line from the plastic dispenser spool to pass freely on through the rod guides to be connected to the lure or bait for casting. The grommet around the hole can be made of smooth metal, plastic, Teflon, hard neoprene rubber, or other material and lessens line abrasion while casting.
m. Unique placement of the fishing reel frame with gear box directly under the horizontally mounted lidded line spool canister.
